(19) United States
(12) Patent Application Publication
(10) Pub. No.: US 2008/0081146 A1
(43) Pub. Date: Apr. 3, 2008

(54) BASE PLATE FOR BUILT-IN ELECTRICAL DEVICE

(76) Inventor: Cristina Egea Soler, Barcelona (ES)

Correspondence Address: Striker, Striker & Stenby, 103 East Neck Road, Huntington, NY, 11743, US

(21) Appl. No.: 11/861,556

(22) Filed: Sep. 26, 2007

(30) Foreign Application Priority Data
Sep. 28, 2006 (ES) 20060117

(51) Int. Cl. B32B 3/06

(52) U.S. Cl. 428/99

(57) ABSTRACT

In a base plate for built-in electrical device covers are fitted through pressure by slotting triangular-shaped projections and have a chromatic finish that is distinct from the base plate, so that when one of the covers is fitted over the corresponding plate, chromatic aspect of an ensemble is changed, which can be achieved with different plate covers having different chromatic finishes.

### CROSS-REFERENCE TO A RELATED APPLICATION

The invention described and claimed hereinbelow is also described in Spanish Patent Application 20060117 filed on Sep. 28, 2006. This Spanish application, which subject matter is incorporated here by reference provides the basis for a claim of priority of invention under 35 U.S.C. 119(a)-(d).

### BACKGROUND OF THE INVENTION

The present invention relates to base plates used for installing and mounting built-in command and control electrical devices, whose plates, suitably attached to the metal frame for fixing of the built-in electrical devices, close and perfectly hide that area, leaving visible from the outside only the base plate itself, together with the element for actuating the electrical device or other accessory element such as rocker switches or keys, etc.

### SUMMARY OF THE INVENTION

Precisely the fact that only the base plate is visible from the outside of the built-in electrical device, together with the element situated in its central area, makes this repeatedly cited plate an element of considerable importance from the aesthetic and decorative point of view.

Experts in interior design, when designing the area or areas to be decorated, whether in private residences or places used as offices, studios and similar, wish to have electrical elements in harmony with the décor, by using base plates in an appropriate chromatic finish, in addition to actuating devices such as rocker switches or keys or similar, especially the keys located in the central area of the plate.

However, all of the foregoing presents a notable inconvenience, since when there is a change in décor of the relevant place, the interior design expert may wish to change the chromatic tones of the base plates installed in the various points of the place in question, which has a high cost in terms of both labour for dismantling and subsequent installation of the electrical device, and having to buy a new plate with a different chromatic appearance, throwing away the existing one long before its useful life is over.

The base plates that form the object of the present invention offer a practical and financially economical solution to the abovementioned problems, since they offer the possibility of fitting on the installed base plate, without the need for any accessory, a cover in the right chromatic tone, meaning that the decorator or interior design specialist can have the required tone for the designed ensemble.

In addition to the foregoing, this invention presents the possibility of installing covers in different chromatic tones on the switch, generally of the rocker type, installed in the central area of the base plate, and likewise, the intermediate fitting of frames, installed in the opening or central window of the base plate, frames which, in a practical embodiment of the invention, would have a folding lid, of enormous use for electrical devices such as sockets, since the lid would protect the area at a lower level, where the socket base mechanism is located.

### BRIEF DESCRIPTION OF THE DRAWINGS

FIG. 1 is an exploded persective view of the components of the practical embodiment of the electrical mechanism actuated by the rocker switch, object of the invention, showing the cover of the base plate drawn firstly in outline next to the exploded assembly, like the rocker switch cover, also drawn in a dotted line. Both covers also appear fully drawn in the corresponding place;

FIG. 2 is a perspective view similar to that of the preceding figure, with the corresponding covers also represented by means of dotted lines and in the corresponding place in a continuous line, for the embodiment of the double electrical mechanism, activated through the two half-module rocker keys;

FIG. 3 is a similar view to that of the previous two drawings, and especially the 1^{st}, with an intermediate frame situated around the switch.

FIG. 4 is a similar view to that of the three preceding drawings, in the embodiment of a double electrical device and two half-module keys, equipped with an intermediate frame situated around the two keys;

FIG. 5 is a bottom perspective view, according to FIG. 2, showing the base plate, its cover, a key cover and two covers for two half-module keys for the embodiment as a double electrical mechanism;

FIG. 6 is an exploded perspective view of an embodiment of a plug socket electrical device, with the base plate and cover for it;

FIG. 7 is an embodiment represented in an equivalent manner to the preceding figure in which the plate is fitted with an intermediate frame;

FIG. 8 is a similar view to that of the preceding drawing, but with the intermediate frame incorporating a folding lid.

FIG. 9 is a section view of the base plate with its cover fitted on it, showing how it is attached;

FIG. 10 is a close-up, in larger scale, of the way of fitting the cover on to the base plate as shown in FIG. 9;

FIG. 11 is a section view of a key with its cover fitted;

FIG. 12 is a section of a key with its cover fitted;

FIG. 13 is a section view of the base plate with an intermediate frame installed on it;

FIG. 14 is a similar section to that of the preceding drawing, but with the intermediate frame fitted with a folding lid that is lifted open; and

FIG. 15 is a close-up, in larger scale of the fitting of the intermediate frame, with or without the folding lid, on the base plate.

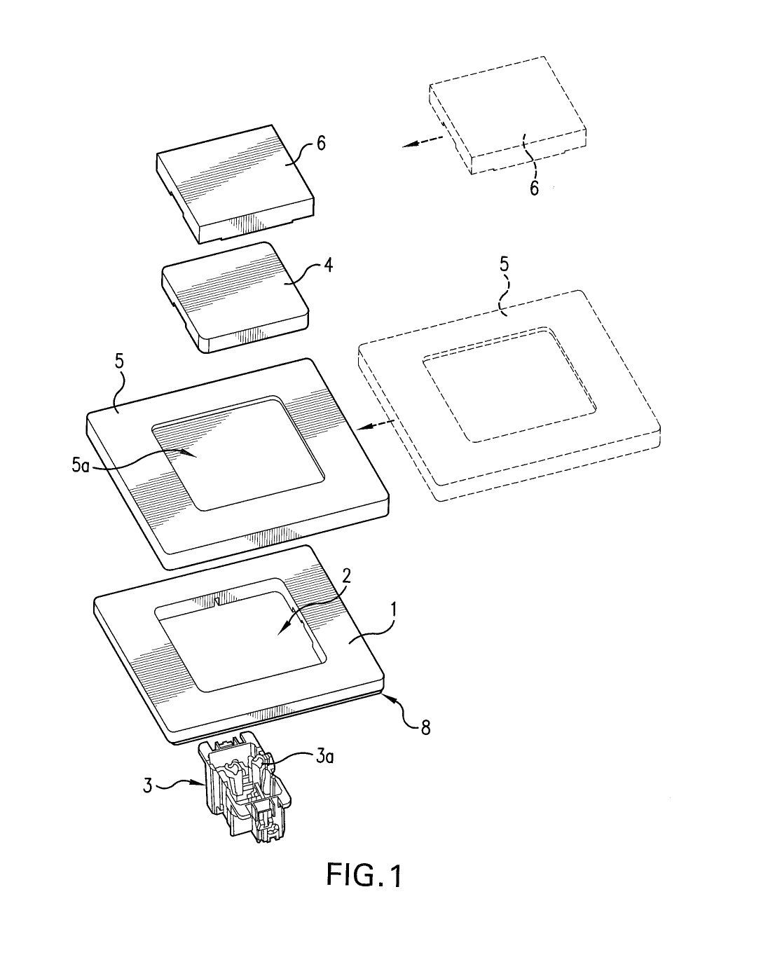

### DESCRIPTION OF THE PREFERRED EMBODIMENTS

In accordance with all of these drawings, the present invention consists of a base plate (1), with its central window (2), situated, in the embodiment of this description, slightly displaced towards the upper end of greater length.

Beneath this base plate (1) is situated the relevant electrical device (3) while above the plate, and coinciding with the window (2), in terms of position and size, the actuating rocker key (4) is installed.

This rocker key (4) is fixed by means of protrusions (4a) which slot onto the rocker arm (3a) of the electrical device (3).

On the base plate (1) suitably fitted is the plate cover (5), of the right dimensions for the base plate and made of a sufficiently elastic material for the cover to fit appropriately over the base plate (1), a cover with the right chromatic finish, according to the user's requirements.

A cover (6) of similar characteristics is likewise fitted appropriately over the rocker key (4), a cover that also has the right chromatic finish for the assembly's decorative requirements.

The plate cover (5) has a window (5a) of the same size and in the same location as the window (2) of the base plate (1) for ideal fitting and adjustment.

The plate cover (5) has by the lower edge of its two side faces, appropriate triangular section projections (7), in the form of a nail, which through pressure jut into the side rims (8) that the base plate has on its lower edge. Hollows (7a) situated next to the projections (7) by the edge of the cover (5) facilitate the removal of the cover while notches (8a) located beneath the rim (8) also facilitate the removal operation.

The cover of the key (6) in turn possesses a rim (9) by its lower perimeter, constituting a groove (9a) in a right angle that fits underneath the lower edge (10) of the rocker key (4). This rim (9) of the key cover (6) is rounded throughout its surface, as shown in FIGS. 11 and 12.

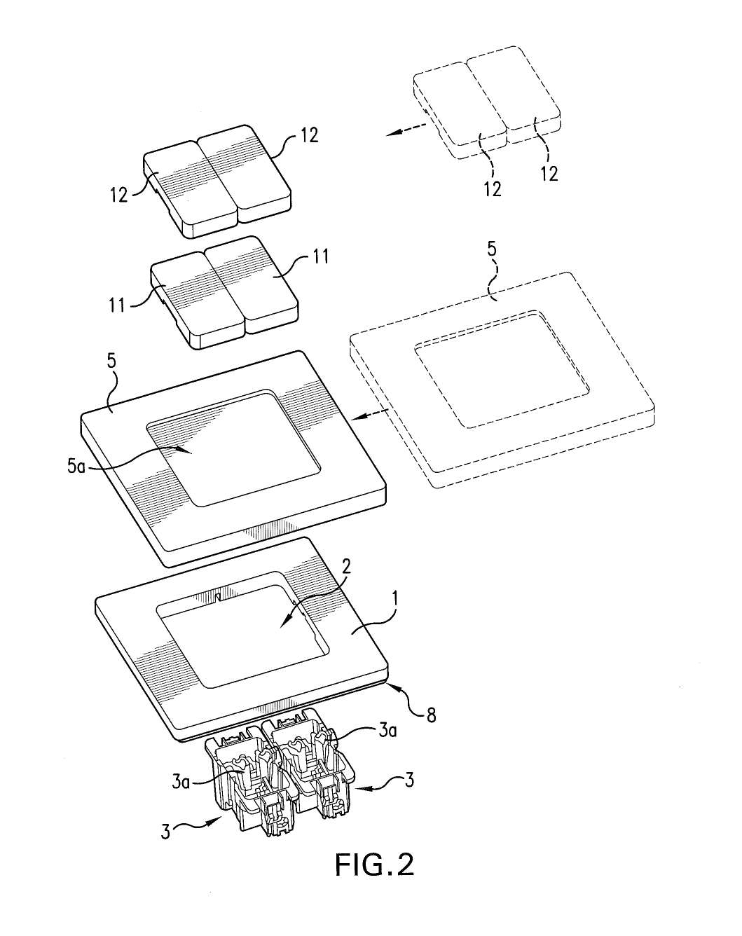

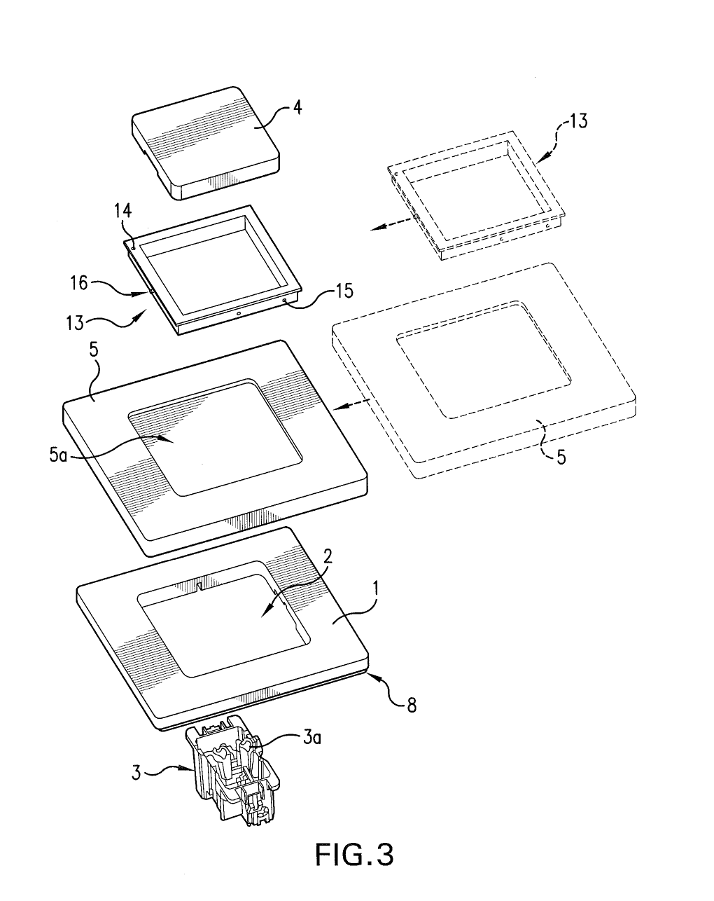

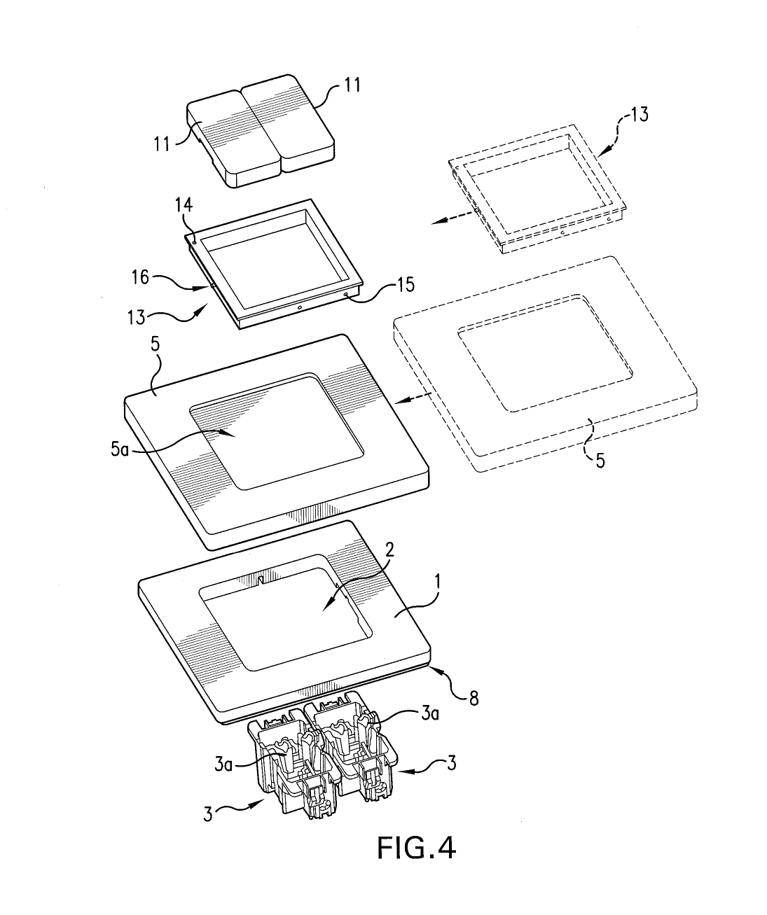

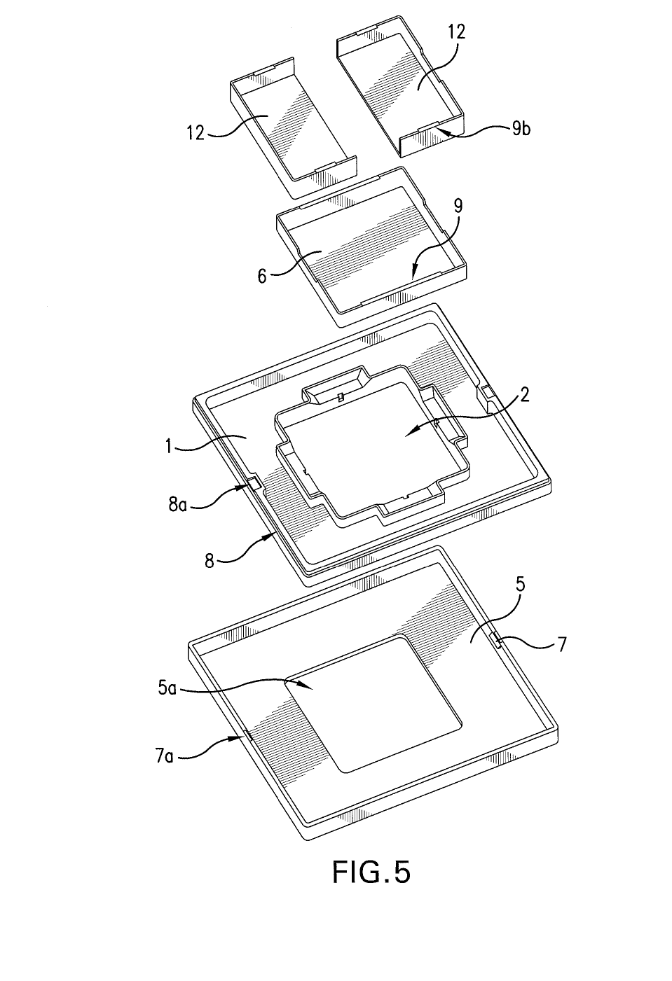

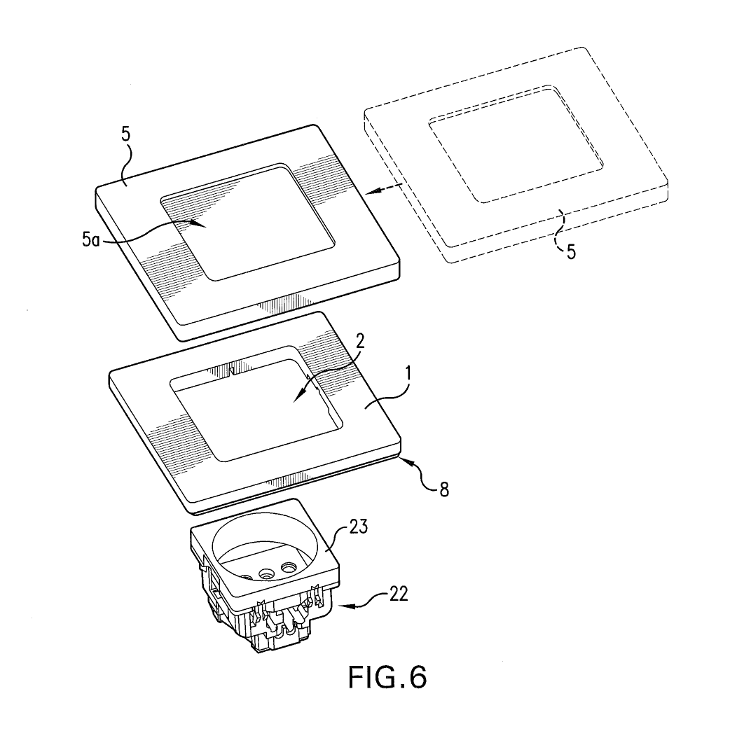

In the embodiment shown in FIG. 2, the assembly contemplates two electrical devices (3), with the base plate (1) and the plate cover (5) the same as in the embodiment described above, varying, as is evident, in the two half-module rocker keys (11), each one for actuating the corresponding electrical device (13).

On these half-module keys (11) respective covers (12) are fitted, with identical characteristics as those of key cover (6), both in terms of the type of material and chromatic finish, and means for fixing to the respective half-module keys (11).

Both in the embodiment with a single rocker key (6) and in the embodiment with the two half-module rocker keys (11), an intermediate frame (13) can be fitted, identical in both embodiments, a frame that can be fitted into the window (2) of the base plate (1), leaving its upper face (14) visible, above the upper face of the base plate (1) itself.

This intermediate frame (13) has on its side faces (15) triangular section projections (16) whose flat face slots beneath the inner rim (17) of the window (2) of the base plate (1), as shown in FIGS. 13 and 15.

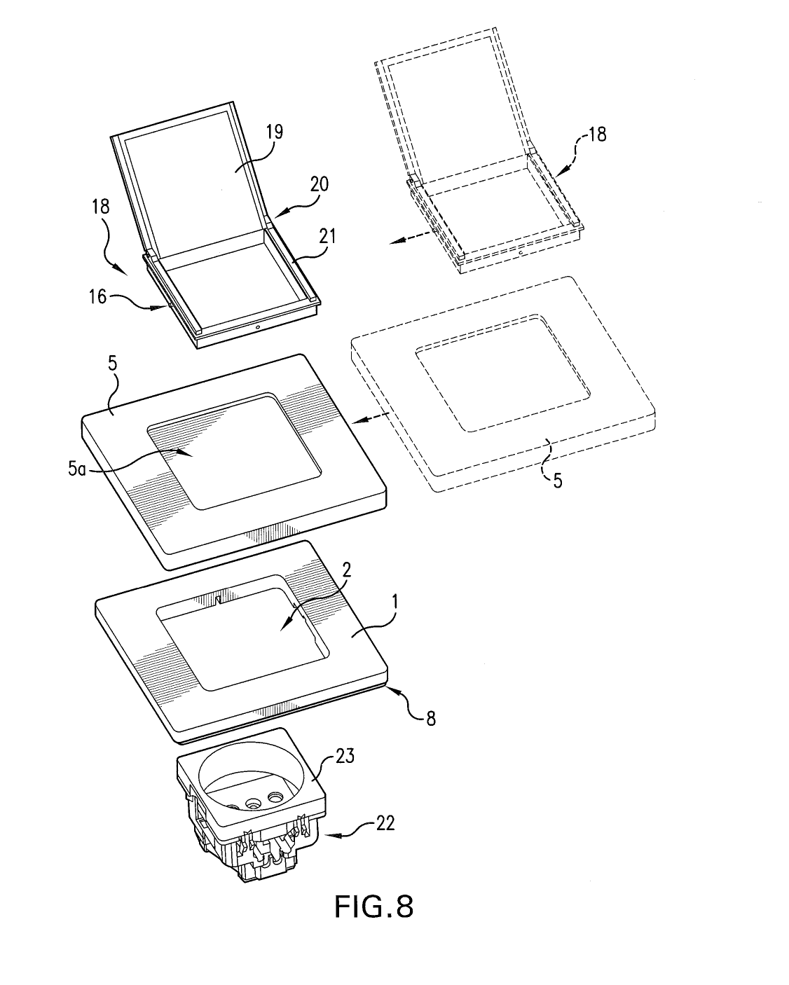

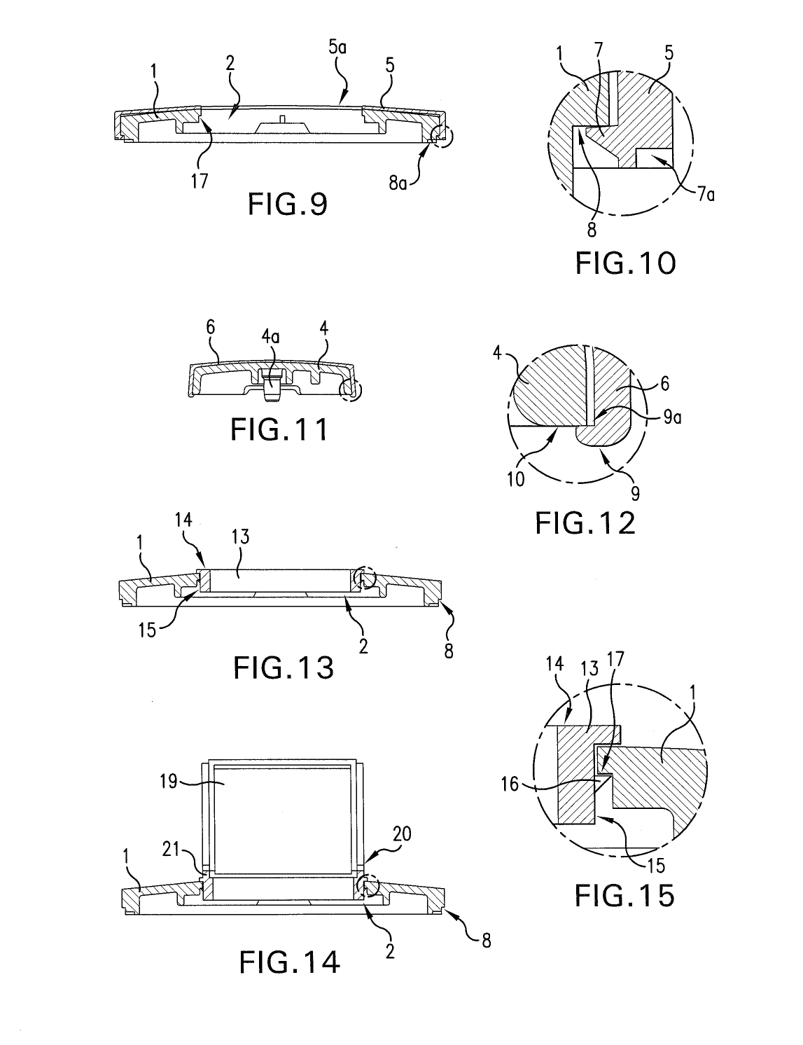

Said intermediate frame presents a variation of its embodiment as a frame (18) with a folding lid (19), equipped with the necessary hinges (20) in its rear zone in addition to side thickening parts (21) for fitting this folding lid (19) on to the intermediate frame (18), all as shown in FIGS. 8 and 14.

Finally, in the embodiment of the electrical mechanism for a plug socket (22) this mechanism is positioned by slotting the upper square part (23) of its body in the window (2) of the base plate (1), base plate on which the appropriate plate cover (5) is fitted.

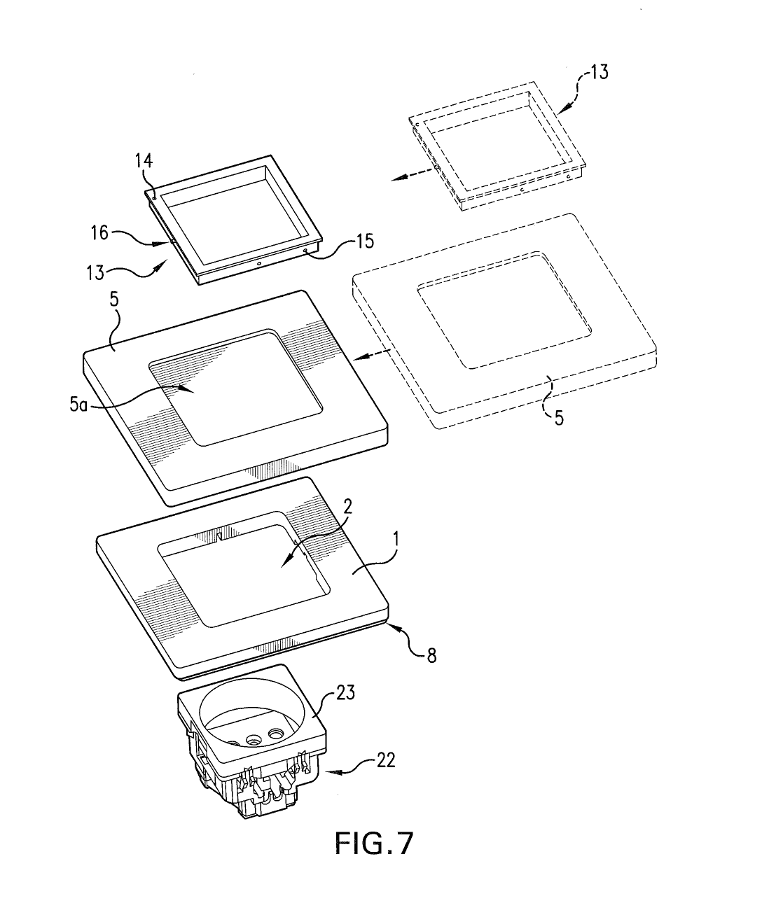

As shown in FIGS. 7 and 8, the intermediate frame (13) is placed on the perimeter edge of the window (2), as, in the embodiment with an evidently protective purpose, the intermediate frame (18) equipped with the folding lid (19), which avoids passing inside the upper part (23) of the plug socket mechanism (22).

Having sufficiently described the object of the present invention referred to in the present specification, any variation in size, shape, chromatic tones, and types of materials used to realize it, in no way alters the essence of the invention, as summarised in the following claims.

1. Base plates for built-in electrical devices, with fittable chromatic covers and intermediate frames, whose plates, duly fixed to the metal frame or other fixing material of the built-in electrical mechanism (3) constitute the element visible from the outside, together with the rocker key (4) for actuating such mechanism (3) or other accessory element located in it, characterised in that they present covers (5) fitted through pressure, by slotting triangular-shaped projections (7), which they have on their edge, beneath the lower side rim (8) of said base plates (1), with these covers (5) having a chromatic finish, totally distinct from the base plates (1), all in such a way that when one of these plate covers (5) is fitted over the corresponding plate (1), the chromatic aspect of the ensemble is changed, an objective that can be achieved as many times as necessary by using different plate covers (5) with different chromatic finishes.

2. Base plates for built-in electrical devices, according to claim 1, characterised in that over the rocker key (4) for actuating the electrical mechanism (3), situated in the window (2) of the base plate (1) there is a key cover (6) with a different chromatic finish to that of the key itself (4), a cover that is fitted through pressure by the slotting of its lower rim (9) against the lower edge of the rocker key itself (4), all in such a way that when a key cover (6) is fitted over the corresponding key (4), the chromatic aspect of the ensemble is changed, contemplating the possibility of having two half-module rocker keys (11) to actuate two distinct electrical mechanisms (3), on which respective covers (12) are also fitted, through pressure like the key covers (6).

3. Base plates for built-in electrical devices, according to claim 1, characterised in that they contemplate the installation of a plug socket mechanism (22), whose upper square part (23), is positioned in the central window (2) of the base plate (1), in which an intermediate frame is also fitted (13), whose upper face (14) offers a suitable chromatic finish for its signposting and location, leaving the side wall (15) jutted into the inside of the window (2) by means of triangular projections (16) that it has on the outside, which hook into a lower perimeter rim (17) of said window (2) of the base plate (1).

4. Base plates for built-in electrical devices, according to claim 1, characterised in that they offer the possibility of having an intermediate frame (13) (18) with such frame having a folding lid (19) by means of rear hinges (20) and provided in turn with side thickening parts (21) for fitting the lid over the frame, whose lid (19) protects the holes in the upper part (23) of the plug socket mechanism (22), and as the outside upper part of the cited frame (18) ensuring the function of chromatic differentiation.

5. Base plates for built-in electrical devices, according to claim 1, characterised in that the intermediate frame (13) can be applied in the embodiment of the electrical mechanism or mechanisms (3), actuated by a rocker key (4), or two half-module rocker keys (11), positioning this frame (13) on the perimeter contour of the window (2) of the base plate (1) and always having its upper face (14) visible.

6. Base plates for built-in electrical devices, according to claim 1, characterised in that the size of their sides may vary in thickness, and preferably being less thick on the longer sides than on the shorter ones, obliging, for this reason, the sizes of the plate covers to be adjusted for their correct fitting.
